(19) United States
(12) Patent Application Publication
(10) Pub. No.: US 2008/0300873 A1
(43) Pub. Date: Dec. 4, 2008

(54) Systems And Methods For Securely Transcribing Voicemail Messages

(76) Inventor: James Siminoff, Miami Beach, FL (US)

Correspondence Address: LATHROP & GAGE LC, 4845 PEARL EAST CIRCLE, SUITE 300, BOULDER, CO, 80301, US

(21) Appl. No.: 12/126,298

(22) Filed: May 23, 2008

Related U.S. Application Data
(60) Provisional application No. 60/940,864, filed on May 30, 2007.

(51) Int. Cl. G10L 15/26

(52) U.S. Cl. 704/235; 704/E15.043

(57) ABSTRACT

A system or method for securely transcribing voicemail messages includes answering a call within a secure communication provider, the secure communication provider recording audio of the call, sending the audio to a voicemail transcription service via a secure communication link, transcribing the audio into text, and sending the text to the secure communication provider via the secure communication link, the audio and the text not being permanently stored and not being available for interpretation by humans during this transcription method.

### RELATED APPLICATIONS

This Application claims priority to provisional patent Application No. 60/940,864, filed May 30, 2007, the entire disclosure of which is incorporated by reference herein.

### BACKGROUND

A communication subscriber may utilize a voicemail transcription service to transcribe voicemail messages into text. Such services are known in the art and typically deliver the transcribed text to the subscriber as an email message and/or one or more text messages.

The voicemail transcription service typically requires that the communication subscriber forward unanswered calls to a phone number provided by the voicemail transcriptions service. Calls received on this phone number are recorded as a voicemail message and are then stored within a voicemail box provided by the voicemail transcription service and associated with the communication subscriber. The voicemail message is transcribed into text and stored by the voicemail transcription service for access by the communication subscriber. Optionally, the voicemail transcription service may send the transcribed text to the communication subscriber in the form of an email message (that may also include the audio voicemail message) and/or one or more text messages.

The communication subscriber may utilize a secure communication provider, that is, the communications and stored messages have increased security from theft, as provided by the secure communication provider. However, since voicemail messages and transcriptions thereof are stored in a mailbox located with the voicemail transcription service, security of the information therein is compromised by being stored externally to the secure environment of the secure communication provider. In view of the ready access to, and availability of, computer systems of the voicemail transcription service, its computer systems are less secure than those of the secure communication provider and the secure email service provider. Voicemail messages and associated transcription text stored by the voicemail transcription service are therefore more vulnerable to theft. To maintain information security, subscription to the voicemail transcription service may be denied to the potential subscriber.

### SUMMARY OF THE INVENTION

In an embodiment, a method for securely transcribing voicemail messages includes steps of answering a call within a secure communication provider, the secure communication provider recording audio of the call, sending the audio to a voicemail transcription service via a secure communication link, transcribing the audio into text, and sending the text to the secure communication provider via the secure communication link, the audio and the text not being permanently stored and not being available for interpretation during this transcription method.

In an embodiment, a system for securely transcribing voicemail messages includes a call handler within a secure communication provider for answering a call unanswered by a communication device and for recording audio of the call, a secure communication link between the secure communication provider and a voicemail transcription service, a first data server within the secure communication provider for sending the audio to the voicemail transcription service via the secure communication link, a second data server within the voicemail transcription service for receiving the audio from the first data server via the secure communication link, and a transcriber for transcribing the audio into text, the text being sent to the first data server by the second data server via the secure communication link, the first data server storing the text within a voicemail box of the secure communication provider.

In an embodiment, a method for securely transcribing voicemail messages includes steps of configuring a secure communication provider to forward an unanswered call to a voicemail transcription service, answering the call within the voicemail transcription service, transcribing audio of the call into text, generating an encrypted text message containing the text, and sending the encrypted text message to a communication device. The audio and the text are not permanently stored and are not available for interpretation within the voicemail transcription service.

In an embodiment, a method for securely transcribing voicemail messages includes steps of configuring a secure communication provider to forward an unanswered call to a voicemail transcription service, answering the call within the voicemail transcription service, transcribing audio of the call into text, generating an encrypted email message containing the text and/or audio, and sending the encrypted email message to one or more designated email addresses. The audio and the text are not permanently stored or available for interpretation within the voicemail transcription service.

### BRIEF DESCRIPTION OF THE DRAWINGS

FIG. 1 shows an exemplary system for securely transcribing voicemail messages, according to an embodiment.

FIG. 2 shows an exemplary system for securely transcribing voicemail messages, according to an embodiment.

FIG. 3 is a flowchart illustrating an exemplary method for securely transcribing voicemail messages, according to an embodiment.

FIG. 4 is a flowchart illustrating an exemplary method for securely transcribing voicemail messages, according to an embodiment.

### DETAILED DESCRIPTION OF THE DRAWINGS

Voicemail transcription services (and other language transcription services) are now part of everyday communications. If a user of a communication device is unable to take calls, a calling party typically leaves a voicemail message for the user to access when he or she is able. The user may therefore subscribe to a voicemail transcription service where a voicemail left therein for the user is automatically transcribed into text and sent to the user. The user can then read the transcribed voicemail message rather than listen to the voicemail message. Where the voicemail transcription service is external to the communication provider, the user's voicemail box and transcribed texts are stored with the voicemail transcription service. If the user requires increased security, it is currently necessary to minimize the information that is external to the communication provider, or to have no information stored externally to the communication provider. It is accordingly a feature of the disclosure hereof to provide a voicemail transcription service that does not store voicemail messages and/or associated transcription texts.

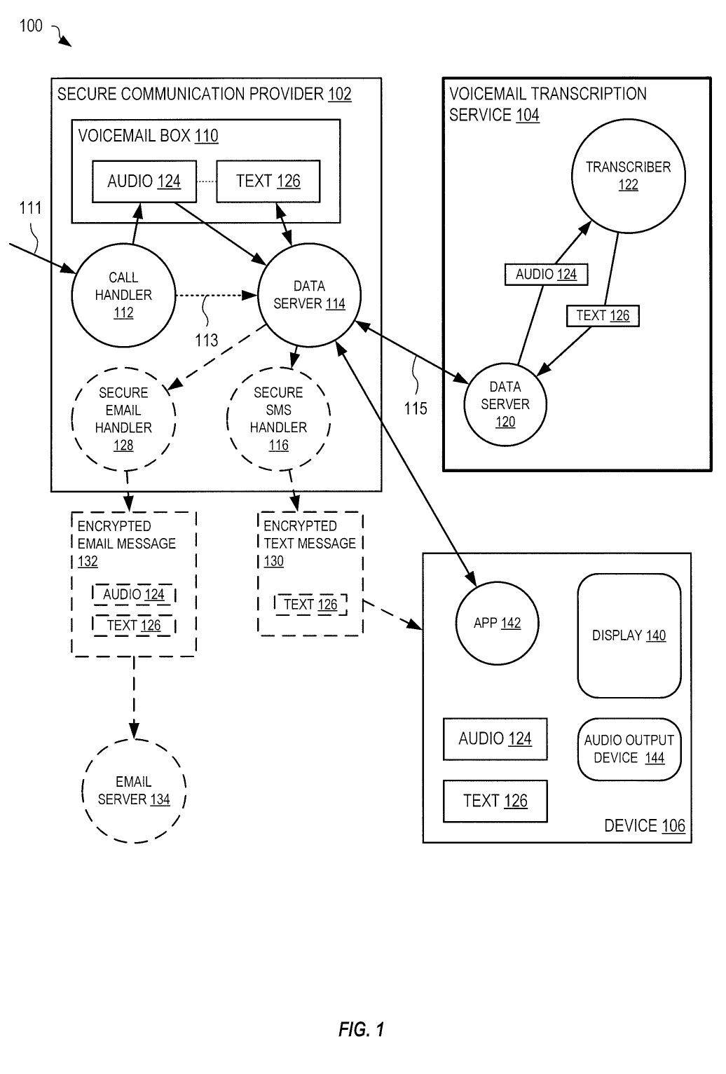

FIG. 1 shows one exemplary system 100 for transcribing voicemail messages securely. System 100 is shown with a secure communication provider 102, a voicemail transcription service 104 and a communication device 106. Communication device 106 is operated by a subscriber (not shown) subscribing to both secure communication provider 102 and to voicemail transcription service 104. Secure communication provider 102 includes, for example, a call handler 112, a data server 114, and a voicemail box 110. Voicemail box 110 is associated with device 106. Voicemail transcription service 104 includes, for example, a data server 120 and a transcriber 122. Device 106 may include a display 140, an application 142, and an audio output device 114. Secure communication provider 102 and voicemail transcription service 104 may be connected by a secure data link 115.

In one example of operation, call handler 112 receives a call 111 for communication device 106. When call 111 is not answered by device 106, call 111 is answered by call handler 112, which then invites a caller to leave a message for the subscriber. Call handler 112 then records audio 124 of call 111 within voicemail box 110. Upon termination of call 111, call handler 112 stops recording of audio 124 and signals 113 data server 114 that audio 124 within voicemail box 110 is complete.

Data server 114 then retrieves audio 124 from voicemail box 110 and sends audio 124, over secure data link 115, to data server 120 of voicemail transcription service 104. Data server 120 forwards audio 124 to transcriber 122 where it is automatically transcribed into text data 126. Transcriber 122 sends text data 126 to data server 120, from where the text data 126 is forwarded to data server 114 via secure data link 115. Since audio 124 and text data 126 are not permanently stored within voicemail transcription service 104, or viewed by an operator of voicemail transcription service 104, information within audio 124 is securely transcribed into text data 126.

Within device 106, the subscriber may utilize voicemail and transcription application 142 to retrieve (via data server 114) and play, using audio output device 144, the audio 124. The subscriber may also utilize voicemail and transcription application 142 to retrieve and display text data 126 as readable text on display 140.

In one embodiment, where security permits, device 106 may include non-volatile memory for storing audio 124 and text data 126, thereby allowing application 142 to play audio 124 and display text data 126 in a form desired by the subscriber, and without needing further interaction with data server 114. In another embodiment, where security does not permit, application 142 retrieves audio 124 and text data 126 each time they are played and viewed respectively, thereby increasing security of information within audio 124 and text data 126 (since they are not permanently stored within device 106). Accordingly, should device 106 become lost, security is still maintained.

Secure communication provider 102 may include other servers and handlers to allow the subscriber access to audio 124 and associated text data 126 within voicemail box 110, without departing from the scope hereof. In one embodiment, secure communication provider 102 includes a secure SMS handler 116 that operates to send at least one encrypted text message 130, containing text data 126, to device 106, thereby delivering text data 126 to the subscriber in another secure manner.

In another embodiment, secure communication provider 102 includes a secure email handler 128 that generates an encrypted email message 132 that contains audio 124 and/or text data 126. Secure email handler 128 sends the encrypted email message 132 to an email server 134 for delivery to one or more predefined email addresses. Since email message 132 is encrypted, email server 134 itself need not be secure.

Secure communication provider 102 may also include a secure web interface (not shown) to allow the subscriber to retrieve audio 124 and/or text data 126 from voicemail box 110 using a secure web browser, for example.

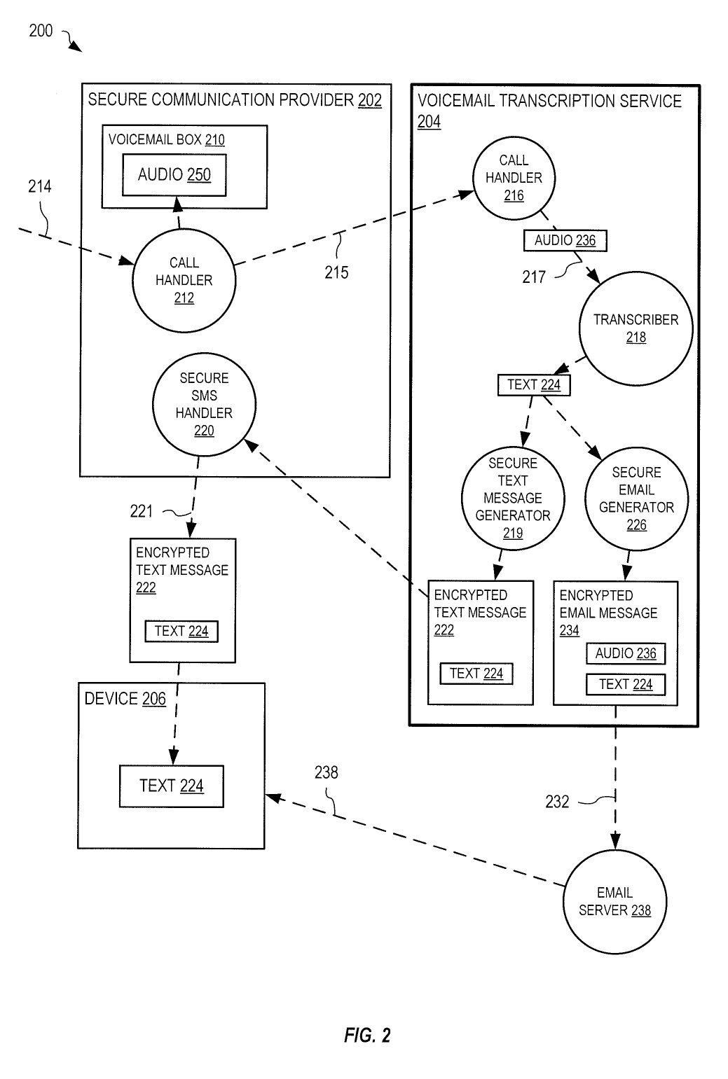

FIG. 2 shows an alternative system 200 for transcribing voicemail messages securely. System 200 has a secure communication provider 202, a voicemail transcription service 204, and a communication device 206. Secure communication provider 202 includes, for example, a call handler 212, a secure SMS handler 220, and a voicemail box 210. Voicemail transcription service 204 may include a call handler 216 and a transcriber 218. Optionally, voicemail transcription service 204 may also include a secure text message generator 219 and/or a secure email generator 226. Communication device 206 is operated by a subscriber subscribing both to secure communication provider 202 and to voicemail transcription service 204. Secure communication provider 202 is configured to forward calls unanswered by device 206 to voicemail transcription service 204.

In one example of operation, call handler 212 receives a call 214 for communication device 206 that is not answered by device 206. Call 214 is then forwarded by call handler 212 as a call 215 to call handler 216 of voicemail transcription service 204. Call handler 216 answers call 215 and invites a caller to leave a message. Call handler 216 then sends audio 236 of call 215 to transcriber 218. Audio 236 is, for example, sent to transcriber 218 as a real-time digital audio stream.

Transcriber 218 transcribes audio 236 into text data 224 and sends text data 224 to secure text message generator 219 and/or secure email generator 226. Secure text message generator 219 generates an encrypted text message 222 containing text data 224 and sends the resulting text message to secure SMS handler 220 for forwarding to device 206. Encrypted text message 222 is encrypted such that only the subscriber (or another authorized party) may decrypt text message 222 to read text data 224 as readable text. Thus, even where text data 224 is contained within multiple encrypted text messages 222, since each encrypted text message 222 is securely encrypted, only the subscriber is able to decrypt encrypted text messages 222 and read text data 224 as readable text.

Since audio 236 and text data 224 are not permanently stored within voicemail transcription service 204 (i.e., there is no copy of audio 236 and no copy of text data 224 stored within voicemail transcriptions service 204), and since operators and other personnel of voicemail transcription service 204 are unable to hear audio 236 and read text data 224, transcription of audio 236 into text data 224 is secure.

In an embodiment, call handler 212 itself records audio of call 214 as audio 250 within voicemail box 210 of secure communication provider 202, thereby allowing the subscriber to alternatively retrieve the audio of call 214 if desired.

In an embodiment, secure email generator 226 generates an encrypted email message 234 containing one or more of audio 236 and text data 224. That is, the subscriber may selectively configure secure email generator 226 to send encrypted email message 234, containing text data 224 and an attached audio file of audio 236, to one or more predefined email addresses. Thus, the subscriber may then utilize email software to retrieve encrypted email message 234 from an email server 238. However, since encrypted email message 234 is encrypted, only the subscriber (or those authorized) may decrypt encrypted email message 234 to hear audio 226 and/or read text data 224 as readable text.

Other methods may be utilized to encrypt and send text data 224 (and audio 236) without departing from the scope hereof.

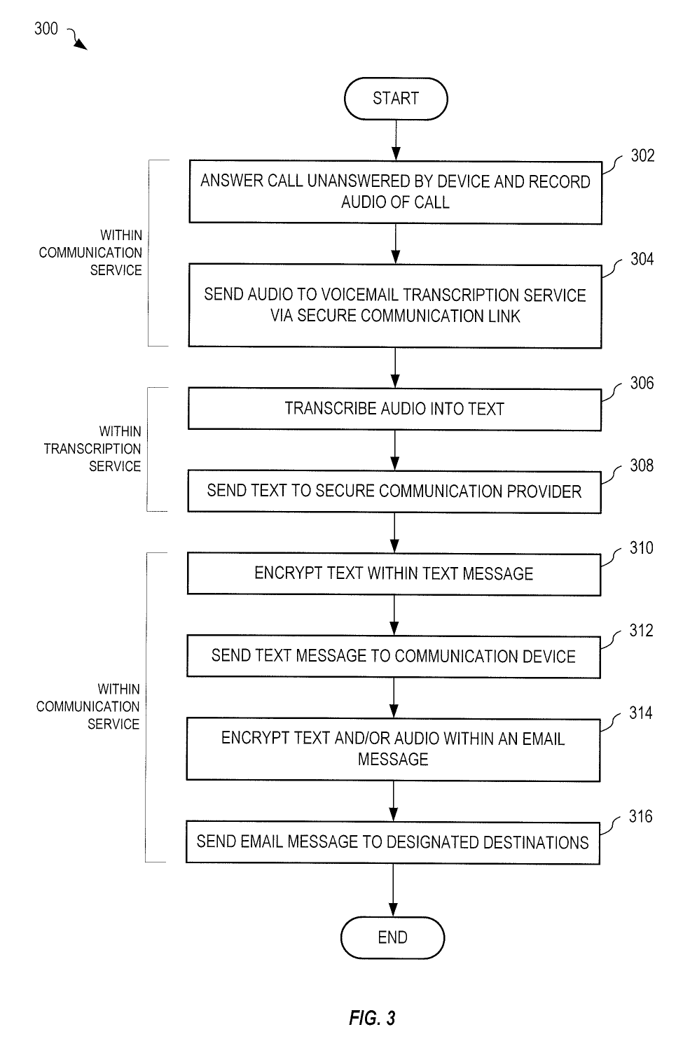

FIG. 3 is a flowchart illustrating an exemplary method 300 for securely transcribing voicemail messages. Steps 302, 304, 310, and 316 may occur within secure communication provider 102. Steps 306 and 308 may occur within voicemail transcription service 104.

In step 302, method 300 answers a call unanswered by the called device and records audio of the call. In an example of step 302, call handler 112 answers call 111 when it is unanswered by device 106 and records audio 124 of call 111, then storing audio 124 within voicemail box 110. In step 304, method 300 sends the audio to voicemail transcription service via a secure communication link. In an example of step 304, data server 114 receives signal 113 from call handler 112 when recording of audio 124 is complete and sends audio 124 to data server 120 of voicemail transcription service 104 via secure communication link 115.

In step 306, method 300 transcribes the audio into text. In an example of step 306, transcriber 122 transcribes audio 124 into text data 126. In step 308, method 300 sends the text to the secure communication provider. In an example of step 308, transcriber 122 sends text data 126 to data server 120 from where the text data 126 is then sent to data server 114 of secure communication provider 102 via secure communication link 115.

Step 310 is optional. In step 310, method 300 encrypts the text within a text message. In an example of step 310, data server 114 sends text data 126 to secure SMS handler 116, where the text data 126 is encrypted into encrypted text message 130. Step 312 is optional. In step 312, method 300 sends the text message to the communication device. In an example of step 312, secure SMS handler 116 sends encrypted text message 130 to device 106. Step 314 is optional. In step 314, method 300 encrypts the text and/or the audio within an email message. In an example of step 314, data server 114 sends text data 126 and/or audio 124 to secure email handler 128 where text data 126 and/or audio 124 are encrypted into encrypted email message 132. Step 136 is optional. In step 316, method 300 sends the encrypted email message to one or more designated destinations. In an example of step 316, secure email handler 128 sends encrypted email message 132 to email server 134 for delivery to the designated recipients.

It should be noted that audio 124 and text data 126 are not stored permanently within voicemail transcription service 104 during steps 306-308.

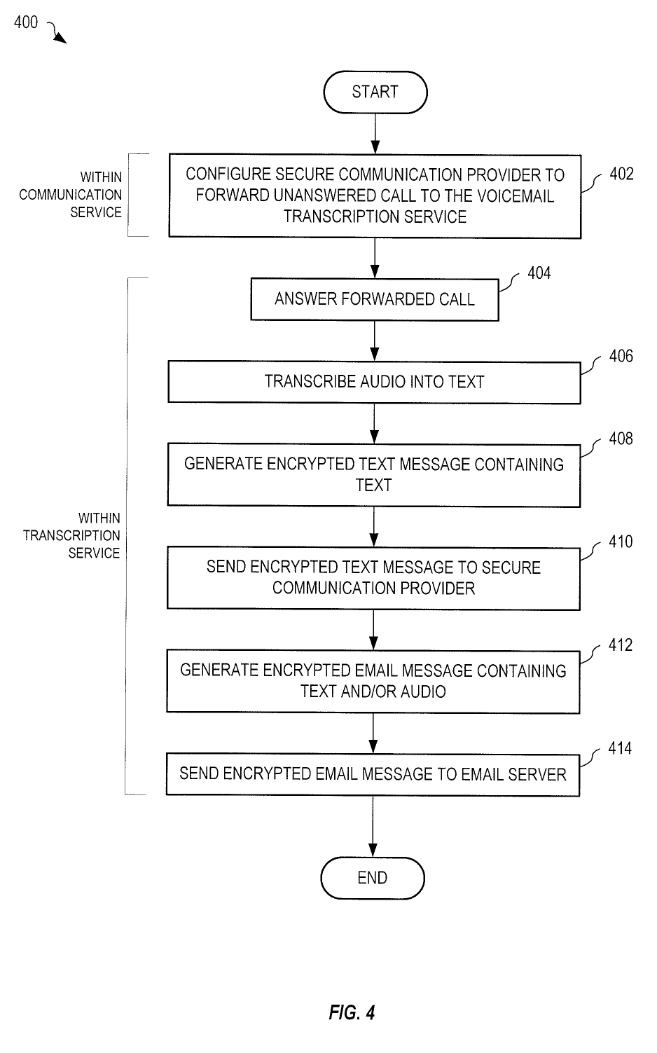

FIG. 4 is a flowchart illustrating an exemplary method 400 for securely transcribing voicemail messages. Step 402 of method 400 may occur within secure communication provider 202. Steps 404-414 may occur within voicemail transcription service 204.

In step 402, method 400 configures secure communication provider to forward unanswered calls to the voicemail transcription service. In an example of step 402, the subscriber configures call handler 212 to forward call 214, when unanswered by device 206, to voicemail transcription service 204 as forwarded call 215.

In step 404, method 400 answers the forwarded call. In an example of step 404, call handler 216 answers call 215 that was forwarded by call handler 212. In step 406, method 400 transcribes audio of the call into text data. In an example of step 406, call handler 216 sends audio 236 of forwarded call 215 to transcriber 218, where audio 236 is transcribed into text data 224.

Step 408 is optional. In step 408, method 400 generates an encrypted text message containing the text data. In an example of step 408, transcriber 218 sends text data 224 to secure text message generator 219, which generates encrypted text message 222 containing text data 224. Step 410 is optional. In step 410, method 400 sends the encrypted text message to the secure communication provider. In an example of step 410, secure text message generator 219 sends encrypted text message 222 to secure SMS handler 220 for delivery to device 206.

Step 412 is optional. In step 412, method 400 generates an encrypted email message containing the text data and/or the audio. In an example of step 412, transcriber 218 sends text data 224 and/or audio 236 to secure email generator 226, which generates encrypted email message 234 containing text data 224 and/or audio 236. Step 414 is optional. In step 414, method 400 sends the encrypted email message to an email server. In an example of step 414, secure email generator 226 sends encrypted email message 234 to email server 238 for delivery to one or more designated email addresses.

It should be noted that audio 236 and text data 224 are not stored permanently within voicemail transcription service 204 during steps 404-414.

Changes may be made in the above methods and systems without departing from the scope hereof. It should thus be noted that the subject matter contained in the above description or shown in the accompanying drawings should be interpreted as illustrative, and not in a limiting sense. The following claims are intended to cover generic and specific features described herein, as well as statements of the scope of the described methods and systems which, as a matter of language, might be said to fall therebetween.

What is claimed is:

1. A method for securely transcribing voicemail messages, comprising the steps of:
answering a call within a secure communication provider, the secure communication provider recording audio of the call;
sending the audio to a voicemail transcription service via a secure communication link;
transcribing the audio into text; and
sending the text to the secure communication provider via the secure communication link, the audio and the text not being permanently stored and not being available for interpretation during this transcription method.

2. A system for securely transcribing voicemail messages, comprising:
a call handler within a secure communication provider for answering a call unanswered by a communication device and for recording audio of the call;
a secure communication link between the secure communication provider and a voicemail transcription service;
a first data server within the secure communication provider for sending the audio to the voicemail transcription service via the secure communication link;
a second data server within the voicemail transcription service for receiving the audio from the first data server via the secure communication link; and
a transcriber for transcribing the audio into text, the text being sent to the first data server by the second data server via the secure communication link, the first data server storing the text within a voicemail box of the secure communication provider.

3. The system of claim 2, further comprising a secure SMS handler for generating an encrypted text message containing the text, and for sending the encrypted text message to the communication device.

4. The system of claim 2, further comprising a secure email handler for generating an encrypted email message containing the text and/or the audio, and for sending the encrypted email message to one or more designated email addresses.

5. A method for securely transcribing voicemail messages, comprising the steps of:
configuring a secure communication provider to forward an unanswered call to a voicemail transcription service;
answering the call within the voicemail transcription service;
transcribing audio of the call into text;
generating an encrypted text message containing the text; and
sending the encrypted text message to a communication device,
wherein the audio and the text are not permanently stored and are not available for interpretation within the voicemail transcription service.

6. A method for securely transcribing voicemail messages, comprising the steps of:
configuring a secure communication provider to forward an unanswered call to a voicemail transcription service;
answering the call within the voicemail transcription service;
transcribing audio of the call into text;
generating an encrypted email message containing the text and/or audio; and
sending the encrypted email message to one or more designated email addresses,
wherein the audio and the text are not permanently stored or available for interpretation within the voicemail transcription service.
